(19) United States
(12) Patent Application Publication
(10) Pub. No.: US 2019/0026650 A1
(43) Pub. Date: Jan. 24, 2019

(54) BOOTSTRAPPING MULTIPLE VARIETIES OF GROUND TRUTH FOR A COGNITIVE SYSTEM

(71) Applicant: International Business Machines Corporation, Armonk, NY (US)

(72) Inventors: Corville O. Allen, Morrisville, NC (US); Andrew R. Freed, Cary, NC (US); Sorabh Murgai, Cary, NC (US)

(21) Appl. No.: 15/658,106

(22) Filed: Jul. 24, 2017

(51) Int. Cl. G06N 99/00; G06F 9/44; G06N 7/02

(52) U.S. Cl. CPC G06N 99/005; G06N 7/023; G06F 9/4401

(57) ABSTRACT

Curating high-quality ground truth is an important but difficult part of training a cognitive system. The invention greatly simplifies this process by determining the value that particular training data has in improving existing ground truth. Candidate training data of different types (text, audio, images) is extracted from an interaction log, and each entry is analyzed to arrive at a training value score. The analysis generates multiple component scores which are combined for the final score. The component scores may include a per-feature variability score, a cross-feature variability score, and an accuracy score. A set of the unverified entries may be presented to a user based on the training value scores, and the user can select which of the entries in the set should be included as new ground truths. The ground truths can then be updated by adding the selected entries.

### BACKGROUND OF THE INVENTION

### Field of the Invention

The present invention generally relates to cognitive analysis (deep learning), and more particularly to a method of providing ground truth for a cognitive system.

### Description of the Related Art

A cognitive system (sometimes referred to as deep learning, deep thought, or deep question answering) is a form of artificial intelligence that uses machine learning and problem solving. Cognitive systems often employ neural networks although alternative designs exist. A modern implementation of artificial intelligence is the IBM Watson™ cognitive technology, which applies advanced natural language processing, information retrieval, knowledge representation, automated reasoning, and machine learning technologies to the field of open domain question answering. Such cognitive systems can rely on existing documents (corpora) and analyze them in various ways in order to extract answers relevant to a query, such as person, location, organization, and particular objects, or identify positive and negative sentiment. Different techniques can be used to analyze natural language, identify sources, find and generate hypotheses, find and score evidence, and merge and rank hypotheses. Models for scoring and ranking the answer can be trained on the basis of large sets of question (input) and answer (output) pairs. The more algorithms that find the same answer independently, the more likely that answer is correct, resulting in an overall score or confidence level.

Cognitive systems rely on ground truth to carry out their analyses. Ground truth is typically paired data, i.e., a sample input and a response, such as a question and an answer. Training data sets can be provided for ground truth, usually with subject matter experts weighing in on which training data is reliable. Curating high-quality ground truth is an important but difficult part of training a cognitive system. Existing approaches include using a brainstorming session to generate what the programmer thinks is representative training data, gamifying ground truth generation (by providing points/badges for creating x amount of ground truth), letting the users decide what kind of ground truth they will generate, or dictating what kind of ground truth the users will create, most likely by starting at low-accuracy components.

### SUMMARY OF THE INVENTION

The present invention in at least one embodiment is generally directed to a method of providing instances of training data for a cognitive system by receiving a log of interactions representing separable pieces of potential training data for the cognitive system, extracting a plurality of unverified entries from the log, analyzing each unverified entry to generate a respective training value score indicative of an improvement to the cognitive system relative to existing ground truths, and selecting one or more of the unverified entries as new ground truths for the cognitive system based on the training value scores. The analysis can include generating multiple component scores which are then combined for the final training value score. The component scores may include (i) a per-feature variability score based on any change to statistical information regarding features of the training data that would be imposed by including a given unverified entry in the ground truths, (ii) a cross-feature variability score based on clustering of the ground truths according to the features and which cluster a given unverified entry would fall in, and (iii) an accuracy score based on the accuracy of the cognitive system for the particular type of a given unverified entry. A set of the unverified entries may be presented to a user based on the training value scores, and the user can select which of the entries in the set should be included as new ground truths. The ground truths can then be updated by adding the selected entries.

The above as well as additional objectives, features, and advantages in the various embodiments of the present invention will become apparent in the following detailed written description.

### BRIEF DESCRIPTION OF THE DRAWINGS

The present invention may be better understood, and its numerous objects, features, and advantages of its various embodiments made apparent to those skilled in the art by referencing the accompanying drawings.

FIG. 1 is a block diagram of a computer system programmed to carry out ground truth generation and selection for a cognitive system in accordance with one implementation of the present invention;

FIG. 2 is a block diagram of a training system for a cognitive system in accordance with one implementation of the present invention which extracts candidate training data, scores that data, and updates the cognitive system ground truth using selected training data;

FIGS. 3A-3C are pictorial representations of different techniques for scoring candidate training data based on the potential improvement to a cognitive system having existing ground truth in accordance with one implementation of the present invention; and

FIG. 4 is a chart illustrating the logical flow for a ground truth selection process in accordance with one implementation of the present invention.

The use of the same reference symbols in different drawings indicates similar or identical items.

### DESCRIPTION OF THE PREFERRED EMBODIMENT(S)

In cognitive systems, the quality of the ground truth directly correlates to the quality of the trained system, yet ground truth curation is so time-consuming and tedious that often times systems do not get enough ground truth to train on in order to perform reliably. Conventional approaches often involve subjective decisions as to what training data is most representative, but it rarely is in actuality. For many systems, there is much potential training data available, but there is no guidance for users to select the most helpful data to convert into ground truth. Consequently, they often do not make the best use of their time resulting in inferior training data, as there are not enough resources (time/money/effort) to convert all of the available training data to ground truth. Additionally, most existing methods focus on building one specific type of ground truth at a time, so while a cognitive system may be accurate in a narrow field, it more generally performs poorly.

It would, therefore, be desirable to devise an improved method of generating multiple types of ground truth at a time, with intelligence to generate more ground truth for the areas where it is needed most. It would be further advantageous if the method could select instances of training data that are most likely to prove beneficial to the system, increasing the return on resource investment. These and other objectives are achieved in various embodiments of the present invention by determining the variability of potential training data to improve system accuracy. Existing ground truth is evaluated and new training data (that may be converted to ground truth by subject matter experts or other means) is examined relative to the existing ground truth to see how variable the potential training data is.

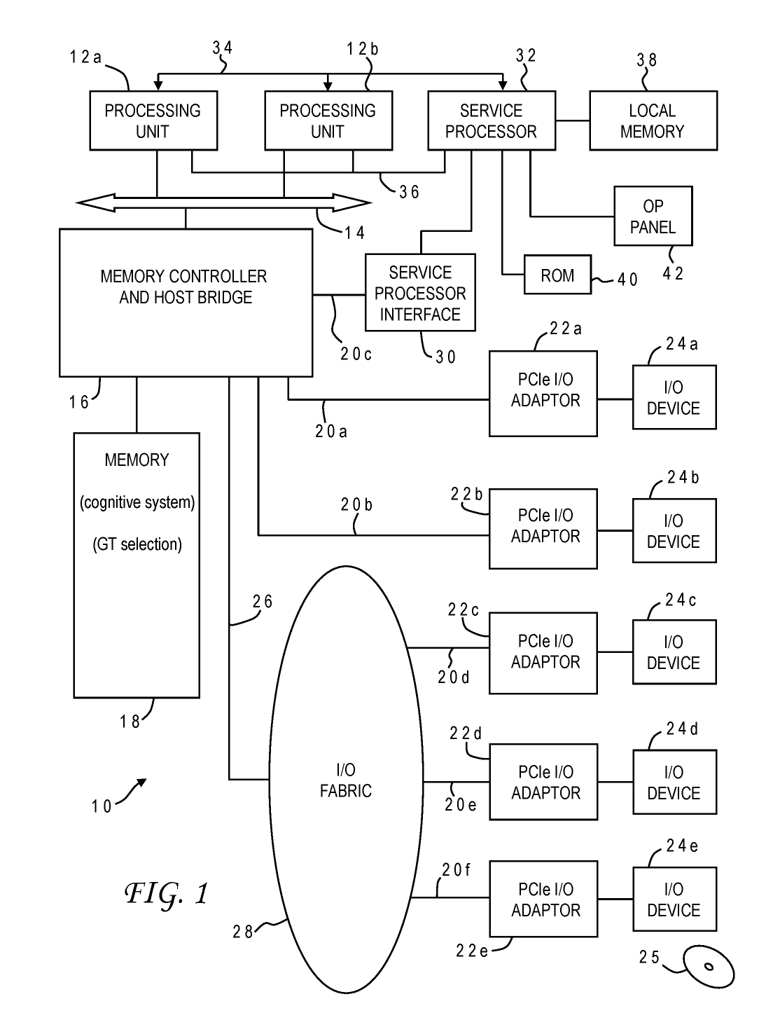

With reference now to the figures, and in particular with reference to FIG. 1, there is depicted one embodiment 10 of a computer system in which the present invention may be implemented to generate and select training data as ground truth for a cognitive system. Computer system 10 is a symmetric multiprocessor (SMP) system having a plurality of processors 12a, 12b connected to a system bus 14. System bus 14 is further connected to and communicates with a combined memory controller/host bridge (MC/HB) 16 which provides an interface to system memory 18. System memory 18 may be a local memory device or alternatively may include a plurality of distributed memory devices, preferably dynamic random-access memory (DRAM). There may be additional structures in the memory hierarchy which are not depicted, such as on-board (L1) and second-level (L2) or third-level (L3) caches. System memory 18 has loaded therein one or more applications in accordance with the present invention, such as the cognitive system itself, and a ground truth selection program.

MC/HB 16 also has an interface to peripheral component interconnect (PCI) Express links 20a, 20b, 20c. Each PCI Express (PCIe) link 20a, 20b is connected to a respective PCIe adaptor 22a, 22b, and each PCIe adaptor 22a, 22b is connected to a respective input/output (I/O) device 24a, 24b. MC/HB 16 may additionally have an interface to an I/O bus 26 which is connected to a switch (I/O fabric) 28. Switch 28 provides a fan-out for the I/O bus to a plurality of PCI links 20d, 20e, 20f These PCI links are connected to more PCIe adaptors 22c, 22d, 22e which in turn support more I/O devices 24c, 24d, 24e. The I/O devices may include, without limitation, a keyboard, a graphical pointing device (mouse), a microphone, a display device, speakers, a permanent storage device (hard disk drive) or an array of such storage devices, an optical disk drive which receives an optical disk 25 (one example of a computer readable storage medium) such as a CD or DVD, and a network card. Each PCIe adaptor provides an interface between the PCI link and the respective I/O device. MC/HB 16 provides a low latency path through which processors 12a, 12b may access PCI devices mapped anywhere within bus memory or I/O address spaces. MC/HB 16 further provides a high bandwidth path to allow the PCI devices to access memory 18. Switch 28 may provide peer-to-peer communications between different endpoints and this data traffic does not need to be forwarded to MC/HB 16 if it does not involve cache-coherent memory transfers. Switch 28 is shown as a separate logical component but it could be integrated into MC/HB 16.

In this embodiment, PCI link 20c connects MC/HB 16 to a service processor interface 30 to allow communications between I/O device 24a and a service processor 32. Service processor 32 is connected to processors 12a, 12b via a JTAG interface 34, and uses an attention line 36 which interrupts the operation of processors 12a, 12b. Service processor 32 may have its own local memory 38, and is connected to read-only memory (ROM) 40 which stores various program instructions for system startup. Service processor 32 may also have access to a hardware operator panel 42 to provide system status and diagnostic information.

In alternative embodiments computer system 10 may include modifications of these hardware components or their interconnections, or additional components, so the depicted example should not be construed as implying any architectural limitations with respect to the present invention. The invention may further be implemented in an equivalent cloud computing network.

When computer system 10 is initially powered up, service processor 32 uses JTAG interface 34 to interrogate the system (host) processors 12a, 12b and MC/HB 16. After completing the interrogation, service processor 32 acquires an inventory and topology for computer system 10. Service processor 32 then executes various tests such as built-in-self-tests (BISTs), basic assurance tests (BATs), and memory tests on the components of computer system 10. Any error information for failures detected during the testing is reported by service processor 32 to operator panel 42. If a valid configuration of system resources is still possible after taking out any components found to be faulty during the testing then computer system 10 is allowed to proceed. Executable code is loaded into memory 18 and service processor 32 releases host processors 12a, 12b for execution of the program code, e.g., an operating system (OS) which is used to launch applications and in particular the ground truth selection program of the present invention, results of which may be stored in a hard disk drive of the system (an I/O device 24). While host processors 12a, 12b are executing program code, service processor 32 may enter a mode of monitoring and reporting any operating parameters or errors, such as the cooling fan speed and operation, thermal sensors, power supply regulators, and recoverable and non-recoverable errors reported by any of processors 12a, 12b, memory 18, and MC/HB 16. Service processor 32 may take further action based on the type of errors or defined thresholds.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computer system 10 carries out program instructions for a ground truth selection process that uses novel analysis techniques to assess the training value of various training data. Accordingly, a program embodying the invention may additionally include conventional aspects of various cognitive analysis tools, and these details will become apparent to those skilled in the art upon reference to this disclosure.

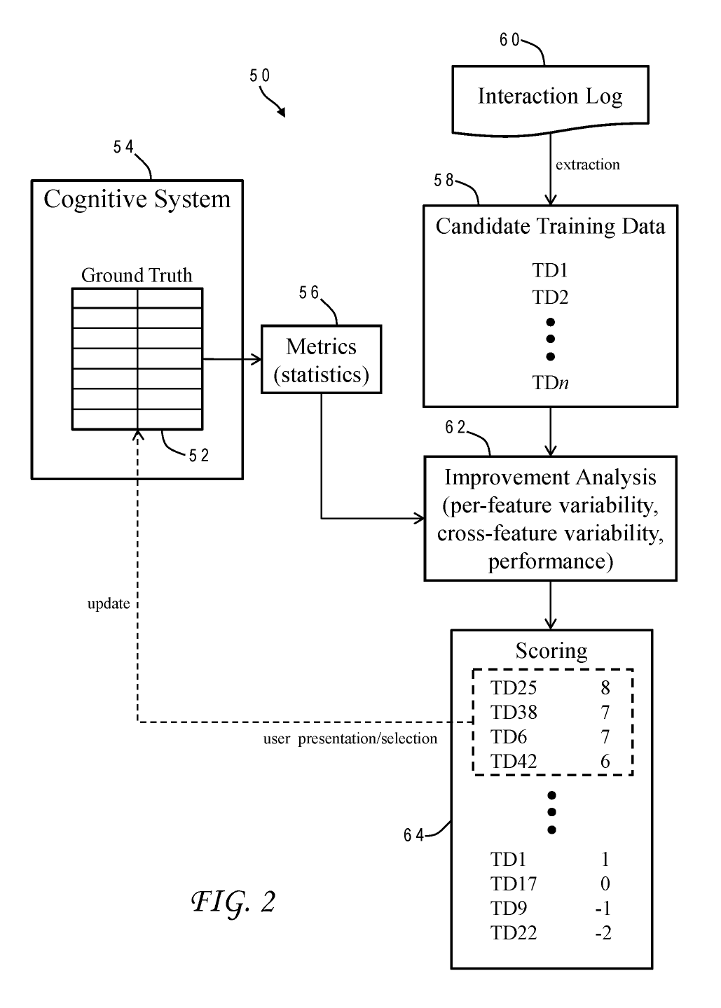

Referring now to FIG. 2, there is depicted a training system 50 for intelligent bootstrapping of ground truth generation. System 50 uses existing ground truth 52 from the cognitive system 54 to develop metrics 56 which can be used to evaluate candidate training data 58, as explained in further detail below. Candidate training data 58 can be derived by extracting interactions from an interaction log 60. The nature of the interactions can generally be described as an input and a response. For a question input the response is an answer, but there are many other types of interactions. In image classification, each image is an input and a corresponding classification chosen by the system is the response; for example, a picture of a dog might be an input and the response might be the word “dog” or “animal”. In text classification, the input might be a tweet and the response would be an indication of what the tweet was generally about, e.g., politics, sports, travel, etc.; text is preferably distinguished as either short or long, with short text going to a text classifier, and long text going to a full natural language processing (NLP) extraction system. In a dialog system, each set of consecutive statements received constitutes the interaction. Interactions may also be aural in nature, i.e., using an audio classifier. Multiple interaction logs can be so provided and different types of interactions extracted, to enable training for each type of interaction required by the cognitive system. Multiple classifiers can be used on the same input data, e.g., a first image classifier which determines the type of animal(s) present in a picture and a second image classifier which determines weather conditions in the picture such as rainy or sunny. Extraction may be performed using the Watson Training Assistant, a cognitive analysis tool available from International Business Machines Corporation.

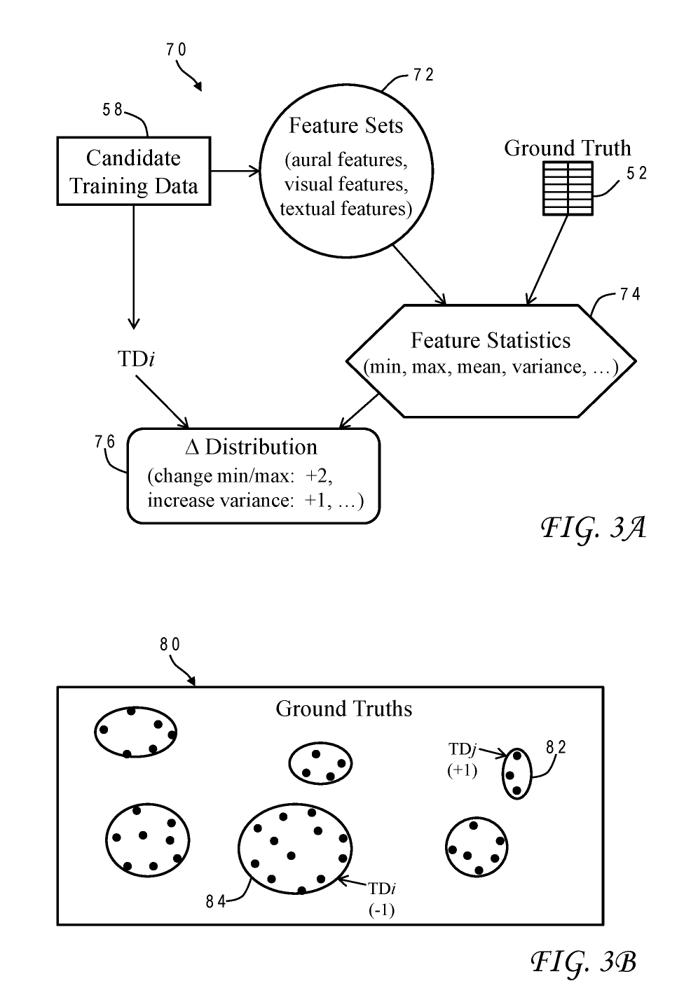

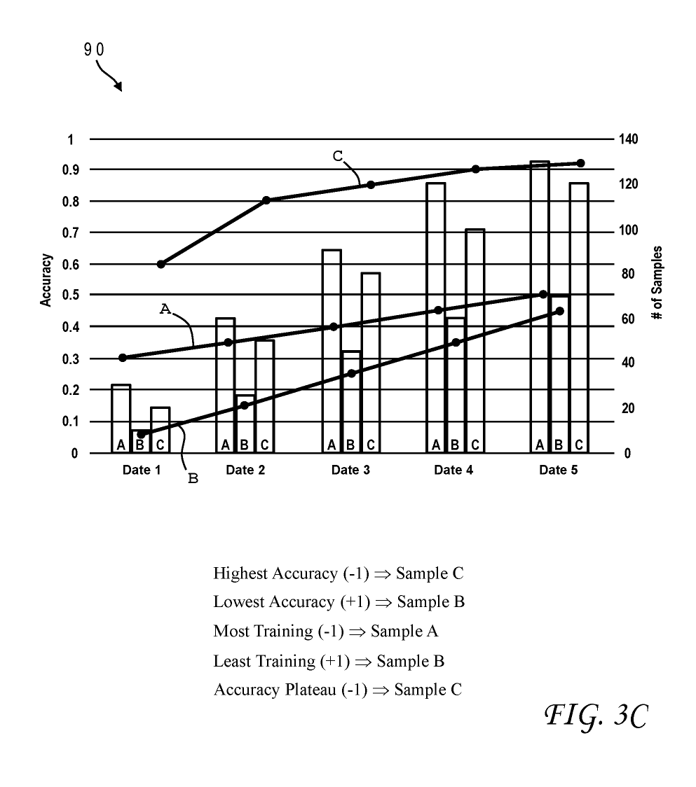

Each of the extracted interactions becomes a candidate (unverified) training data set TDi. This candidate training data is analyzed 62 relative to the metrics 56 gathered from the ground truth 52 to yield a score for each piece of training data. The analysis determines where additional training is needed, i.e., where additional training data will have the most positive impact on the cognitive system. In the illustrative implementation, the overall scores 64 are a composite based on three different scores for each piece of training data corresponding to per-feature variability, cross-feature variability, and performance of the cognitive system as explained below in conjunction with FIGS. 3A-3C. The training data sets with the highest scores can then be used to update the ground truth 52 of cognitive system 54. In the exemplary implementation a user (such as a subject matter expert) logs into training system 50 in order to verify new ground truth entries, but this step can be automated by simply selecting the candidate training data based on either the absolute or relative values of the scores, e.g., picking the top twenty scores, or picking any score over some predetermined threshold value selected by the training administrator.

The invention thus greatly simplifies the task of providing comprehensive ground truth. In the prior art, subject matter experts are typically given a large number of training data sets, e.g., 1000 potential training instances, and asked to identify the most useful ones based on their experience, but they often cannot get around to considering all of the training data. The approach of the present invention initially culls the training data to present the sets that are most likely to have meaningful impact on system reliability, e.g., it can present the 100 training instances having the highest scores, allowing the subject matter experts to perform this task much more efficiently.

FIGS. 3A-3C show the three different exemplary approaches for scoring training data. FIG. 3A represents a scoring system 70 used to compute a first score for training data based on per-feature variability. The candidate training data 58 is used to create feature sets 72 for each kind of training data the system encounters, i.e., aural features, visual features, or textual features. The aural features may for example include tone, volume, frequency, length, etc. Visual features may for example include brightness, color palette, size of focus object, etc. Textual features may vary depending upon the sort of text encountered. Any text may have certain features such as vocabulary coverage, term frequency, or term frequency-inverse document frequency (TF-IDF). TF-IDF is a known measure of word rarity, basically a numerical statistic that is intended to reflect how important a word is to a document in a collection or corpus. A snippet of text (e.g., conversational) may have features including snippet length, punctuation, capitalization, and amount of “text-speak”. Larger text documents can include features relating to document classification. For each of the features found in the candidate training data, statistical information 74 is compiled on how those features are present in the ground truth 52. This statistical information 74 comprises a portion of the metrics 56. The feature statistics can reflect a range/distribution of the features, and may include a minimum, a maximum, a mean, and a variance for each feature. Each piece of training data is then scored according to its ability to change this distribution 76. For example, if a given piece of training data TDi would change the minimum or maximum value for a feature, its score may be incremented by +2, and if that training data would increase the variance of a feature, its score may be incremented by +1. Each feature in each piece of training data is so evaluated to arrive at a per-feature variability score for that training data. For example, a single piece of training data may have five different features; for two of those features this training data would alter the minimum or maximum (+4) while the remaining three features would not alter the minimum or maximum, and only one of the features would exhibit an increased variance (+1), so the total per-feature variability score for that training set would be +5.

FIG. 3B represents a scoring system 80 used to compute a second score for training data based on cross-feature variability. For this score, the same features (from all of the candidate training data) are used to cluster the existing ground truths. The difference between the system of FIG. 3A and the system of FIG. 3B is the scope of the variability check, i.e., the per-feature variability is based individually on each feature in a piece of training data, but the cross-feature variability is based on the overall set of features in the training data. Qualitatively, the clusters determine how similar the data sets as a whole are to each other. Any clustering algorithm can be used, such as k-means clustering, resulting in the ground truths being grouped in the feature space as seen in FIG. 3B. This clustering comprises another portion of the metrics 56. New training data can then be evaluated based on which cluster it would fall in, and the relative size of that cluster (i.e., the number of existing ground truths within that cluster). For example, if certain training data TDj would be added to the smallest cluster 82, it is considered more valuable and so would receive a positive score (increment) such as +1, but if other training data TDi would be added to the largest cluster 84, it is considered superfluous and so would receive a negative score (decrement) such as −1. Those skilled in the art will appreciate that more complicated scoring may be used based on where the training data falls in the spectrum of cluster sizes, e.g., +3 for the smallest cluster, +2 for the next to smallest cluster, etc.

FIG. 3C is a chart 90 representing another scoring system used to compute a third score for training data based on performance of the cognitive system relative to the type of training data proposed. In this example, there are three types of training data A, B and C, which accumulate as ground truths over time (A=audio, B=image, C=text classification). The accuracy of the cognitive system for these different types are measured at the different time intervals. Any conventional accuracy measurements may be used, such as thumbs up/down, or F1 measurements. Thumbs up/down is an indication of user feedback, i.e., did they approve or reject the answer. For example, eight thumbs up to two thumbs down would yield an 80% accuracy. F1 is a standard evaluation metric for cognitive systems (see for example the Wikipedia article at URL https://en.wikipedia.org/wiki/F1_score). For text analysis especially, F1 is considered superior to a raw accuracy score. These accuracy measurements comprise another portion of the metrics 56. New training data can then be evaluated based on the accuracy of the system for the corresponding data type. For example, if training data is of the type where the cognitive system has the lowest accuracy (i.e., that training data is the type most needed for improvement), its score may be incremented by +1, whereas if the training data is of the type where the cognitive system already has the highest accuracy, its score may be decremented by −1. Additionally, if the training data is of the type where system has the least ground truth, the score can again be incremented (+1), or if it is of the type where the system has the most ground truth, the score can again be decremented (−1). Other accuracy features can be considered such as accuracy plateauing, i.e., is the accuracy over time for that data type showing minimal improvement, if so that score is also decremented. For the example of FIG. 3C, training data of type A would have a score of −1 since that data type has the most existing ground truth, while training data of type B would have a score of +2 since that data type has the lowest accuracy and the least training (fewest samples), and training data of type C would have a score of −2 since it has the highest accuracy and exhibits accuracy plateauing.

Those skilled in the art will appreciate that other scoring systems may additionally or alternatively be used to arrive at scores for each piece of training data. Once the separate scores (per-feature variability, cross-feature variability, and performance) are computed for a given piece of training data, they are combined to yield an overall score for the training data. Any combination scheme can be used, e.g., simple arithmetic, weighted average, ML-based weighting, etc. Of course, it is not necessary to use a combination of scores as the invention can operate based on only a single scoring system, but this combined scoring approach is considered superior for determining the impact that the candidate training data has on the existing ground truth of the cognitive system.

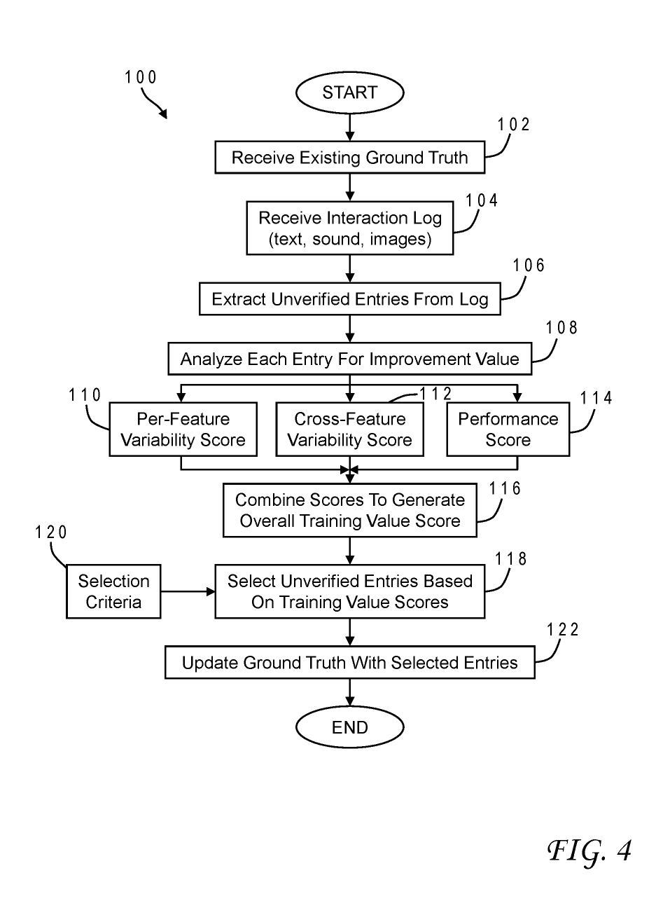

The present invention may be understood with reference to the chart of FIG. 4 which illustrates the logical flow for a ground truth selection process 100 in accordance with one implementation. Process 100 begins by receiving the existing ground truth (102) and receiving the interaction log (104) which may include text, sound, and images. Unverified entries are extracted from the interaction log (106). Each unverified entry is then analyzed to determine its relative value for improving the ground truth (108). This analysis can include generation of a per-feature variability score (110), a cross-feature variability score (112), and a performance (accuracy) score (114). The scores are combined to generate an overall score for each entry representing its training value (116). A set of the unverified entries can then be selected based on the training value scores (118), which may be based on selection criteria (120), including manual selection. The ground truth is then updated by adding the selected entries (122).

This process may be further understood with reference to an example described in conjunction with tables 1-3. Table 1 shows how training data and ground truth can be evaluated according to the features noted above (this table only shows scoring from one type of training data, for this example, audio):

TABLE 1

| | | | | Vari- | |
|---|---|---|---|---|---|
| | Fea- | Fea- | Fea- | ability | |
| Data | ture 1 | ture 2 | ture 3 | Score | Explanation |
| Ground Truth 1 | 100 | 0 | 50 | n/a | |
| Ground Truth 2 | 200 | 0 | 60 | n/a | |
| Ground Truth 3 | 50 | 10 | 50 | n/a | |
| Ground Truth 4 | 120 | 5 | 45 | n/a | |
| Ground Truth 5 | 150 | 1 | 51 | n/a | |
| Ground Truth 6 | 80 | 2 | 50 | n/a | |
| Ground Truth | 50-200, | 0-10 | 45-60 | n/a | |
| Summary | stdev | stdev | stdev | | |
| | 53 | 4 | 5 | | |
| Training Data 1 | 20 | 8 | 58 | 4 | New min for F1 (+2), |
| | | | | | increased variability |
| | | | | | of F2 and F3 (+1, +1) |
| Training Data 2 | 100 | 12 | 59 | 3 | New max for F2 (+2), |
| | | | | | increased variability |
| | | | | | of F3 (+1) |
| Training Data 3 | 180 | 9 | 48 | 2 | Increased variability |
| | | | | | of F1 and F2 (+1, +1) |

In this example, TD1 has the highest per-feature variability score since it both changes the minimum value of the distribution for feature 1 from the ground truth, and increases the variability of feature 2 and feature 3. TD2 has the next highest per-feature variability score since it both changes the maximum value of the distribution for feature 2, and increases the variability of feature 3. TD3 has the lowest per-feature variability score since it only increases the variability of feature 1 and feature 2.

Table 2 shows the same training data applied to ground truth clustering (this table also only shows scoring from one type of training data, for this example, audio):

TABLE 2

| | | Cluster | |
|---|---|---|---|
| Data | Cluster | Score | Explanation |
| Training | A | +1 | Most similar to smallest existing |
| Data 1 | | | ground truth cluster |
| Training | B | 0 | Does not affect largest or |
| Data 2 | | | smallest ground truth cluster |
| Training | C | −1 | Most similar to largest existing |
| Data 3 | | | ground truth cluster |

Table 2 assumes three clusters A (20 entries), B (80 entries) and C (100 entries). TD1 would be included in cluster A, and so would be given a positive score since cluster A is the smallest. TD2 would be included in cluster B, and so would be given a score of zero since cluster B is neither the smallest nor largest. TD3 would be included in cluster C, and so would be given a negative score since cluster C is the largest.

Table 3 shows how these component scores (along with accuracy scores and scores based on the number of ground truths of that type) could be combined for each piece of training data for the audio type, as well as training data for other types (image, text):

TABLE 3

| | | Per-Feature | Cross-feature | | Score For # | |
|---|---|---|---|---|---|---|
| | | Variability | Variability | Accuracy | Of Ground | |
| Data | Type | Score | Score | Score | Truth | Final Score |
| Training Data 1 | Audio | 4 | +1 | 0 | −1 | 4 |
| Training Data 2 | Audio | 3 | 0 | 0 | −1 | 2 |
| Training Data 3 | Audio | 2 | −1 | 0 | −1 | 2 |
| Training Data 4 | Image | 3 | 0 | +1 | +1 | 5 |
| Training Data 5 | Image | 0 | +1 | +1 | +1 | 3 |
| Training Data 6 | Text | 6 | +1 | −1 | 0 | 6 |
| Training Data 7 | Text | 2 | 0 | −1 | 0 | 1 |
| Training Data 8 | Text | 3 | 0 | −1 | 0 | 2 |
| Training Data 9 | Text | 1 | −1 | −1 | 0 | −1 |
| Training Data 10 | Text | 3 | +1 | −1 | 0 | 3 |

Doing a reverse sort on the final score shows which training data to evaluate in which order. A surprising result is found for this example—even though text classification is in the best shape in general, there is a new training data that is high value to the system. The next best results are the single most variable audio/image training data samples. Thus, the invention achieves much more interesting results than just simply going after large blocks of training data in areas where accuracy is considered poor.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. It is therefore contemplated that such modifications can be made without departing from the spirit or scope of the present invention as defined in the appended claims.

1.-7. (canceled)

8. A computer system comprising:
one or more processors which process program instructions;
a memory device connected to said one or more processors; and
program instructions residing in said memory device for providing instances of training data for a cognitive system by receiving existing ground truths for the cognitive system, receiving a log of interactions representing separable pieces of potential training data for the cognitive system, extracting a plurality of unverified entries from the log, analyzing each unverified entry to generate a respective training value score indicative of an improvement to the cognitive system relative to the existing ground truths, and selecting one or more of the unverified entries as new ground truths for the cognitive system based on the training value scores.

9. The computer system of claim 8 wherein the analyzing includes:
identifying at least one feature of the potential training data;
compiling statistical information regarding the feature relative to the existing ground truth; and
generating a per-feature variability score for a given unverified entry based on any change to the statistical information that would be imposed by including the given unverified entry in the ground truths.

10. The computer system of claim 8 wherein the analyzing includes:
identifying at least one feature of the potential training data;
grouping the existing ground truths into a plurality of clusters based on the feature according to a clustering algorithm; and
generating a cross-feature variability score for a given unverified entry based on which of the clusters the given unverified entry would be included in according to the clustering algorithm.

11. The computer system of claim 8 wherein the analyzing includes:
computing accuracies of the cognitive system for different types of ground truths;
determining that a given unverified entry is a particular one of the types; and
generating an accuracy score for a given unverified entry based on the accuracy of the cognitive system for the particular type of the given unverified entry.

12. The computer system of claim 8 wherein the analyzing includes:
generating a per-feature variability score for a given unverified entry;
generating a cross-feature variability score for the given unverified entry;
generating an accuracy score for the given unverified entry; and
combining the per-feature variability score, the cross-feature variability score, and the accuracy score to yield the training value score for the given unverified entry.

13. The computer system of claim 8 wherein the selecting includes:
presenting a set of the unverified entries to a user based on the training value scores; and
receiving a user selection from the set.

14. The computer system of claim 8 wherein said program instructions further update the ground truths with the selected entries.

15. A computer program product comprising:
a computer readable storage medium; and
program instructions residing in said storage medium for providing instances of training data for a cognitive system by receiving existing ground truths for the cognitive system, receiving a log of interactions representing separable pieces of potential training data for the cognitive system, extracting a plurality of unverified entries from the log, analyzing each unverified entry to generate a respective training value score indicative of an improvement to the cognitive system relative to the existing ground truths, and selecting one or more of the unverified entries as new ground truths for the cognitive system based on the training value scores.

16. The computer program product of claim 15 wherein said analyzing includes:
identifying at least one feature of the potential training data;
compiling statistical information regarding the feature relative to the existing ground truth; and
generating a per-feature variability score for a given unverified entry based on any change to the statistical information that would be imposed by including the given unverified entry in the ground truths.

17. The computer program product of claim 15 wherein the analyzing includes:
identifying at least one feature of the potential training data;
grouping the existing ground truths into a plurality of clusters based on the feature according to a clustering algorithm; and
generating a cross-feature variability score for a given unverified entry based on which of the clusters the given unverified entry would be included in according to the clustering algorithm.

18. The computer program product of claim 15 wherein the analyzing includes:
computing accuracies of the cognitive system for different types of ground truths;
determining that a given unverified entry is a particular one of the types; and
generating an accuracy score for a given unverified entry based on the accuracy of the cognitive system for the particular type of the given unverified entry.

19. The computer program product of claim 15 wherein the analyzing includes:
generating a per-feature variability score for a given unverified entry;
generating a cross-feature variability score for the given unverified entry;
generating an accuracy score for the given unverified entry; and
combining the per-feature variability score, the cross-feature variability score, and the accuracy score to yield the training value score for the given unverified entry.

20. The computer program product of claim 15 wherein the selecting includes:
presenting a set of the unverified entries to a user based on the training value scores; and
receiving a user selection from the set.
